(19) United States
(12) Patent Application Publication
(10) Pub. No.: US 2009/0125422 A1
(43) Pub. Date: May 14, 2009

(54) Methods and Systems for Selling Picture Frame Products Through Retailers

(76) Inventors: Carl Ettlinger, Chesterfield, MO (US); Nancy Neiman, Chesterfield, MO (US); Michael W. Bell, St. Louis, MO (US); Michael Flynn, St. Louis, MO (US)

Correspondence Address: HARNESS, DICKEY, & PIERCE, P.L.C, 7700 Bonhomme, Suite 400, ST. LOUIS, MO, 63105, US

(21) Appl. No.: 12/206,498

(22) Filed: Sep. 8, 2008

Related U.S. Application Data
(60) Provisional application No. 60/993,094, filed on Sep. 7, 2007.

(51) Int. Cl. G06Q 30/00

(52) U.S. Cl. 705/27; 705/26

(57) ABSTRACT

A method of increasing sales for a retailer of framing products through a retail website is disclosed. The retailer has a line of framing products including retailer framing products. The method includes providing a back-end database including wholesale framing products not included in said retail framing products. The database is hosted by at least one computer in communication with a computer network. The method includes generating a retail website to provide the line of framing products including at least a portion of said wholesale framing products to a consumer via the computer network and receiving from the retailer a purchase order for at least one of the wholesale framing products. The purchase is order taken by the retailer from the consumer via the retail website.

### CROSS-REFERENCE TO RELATED APPLICATIONS

This application claims the benefit of U.S. Provisional Application No. 60/993,094 filed Sep. 7, 2007.

### FIELD

The present disclosure relates to selling picture frame products through retailers.

### BACKGROUND

The statements in this section merely provide background information related to the present disclosure and may not constitute prior art.

Picture frame products are generally sold through craft stores, locally and over the Internet. The Applicants have recognized that methods of selling picture frame products are often unsatisfactory and have limitations that may be overcome.

### SUMMARY

According to one aspect of the present disclosure, a method of increasing sales for a retailer of framing products through a retail website is disclosed. The retailer has a line of framing products including retailer framing products. The method includes providing a back-end database including wholesale framing products not included in said retail framing products, generating a retail website to provide the line of framing products including at least a portion of said wholesale framing products to a consumer via the computer network, and receiving from the retailer a purchase order for at least one of the wholesale framing products. The purchase order is taken by the retailer from the consumer via the retail website. The database is hosted by at least one computer in communication with a computer network

According to one aspect of the present disclosure, a method of increasing sales for a retailer of framing products through a retail website is disclosed. The method includes generating a retail website hosted by at least one computer in communication with a computer network and receiving at least one user input to build a virtual picture frame product including at least one of the wholesale framing products, storing information in memory accessible via the computer network. The information is sufficient to reproduce the virtual picture frame product and associated with a network designator. The method also includes sending the network designator to the consumer thereby providing access to the virtual picture frame product via the computer network. The retail website is a front-end for a back-end database of wholesale framing products.

According to one aspect of the present disclosure, a system for cutting a picture frame matte based on parameters received via a computer network is disclosed. The system includes a processor, a memory coupled to the processor, a network interface for interfacing the computer network and operatively coupled to the processor, an output device for coupling a matte cutting device, and a program stored in the memory and executable by the processor for receiving a purchase order having parameters for a custom matte via the network interface and directing the matte cutting device via the output device to cut the custom matte according to the parameters.

According to one aspect of the present disclosure, a method for a wholesaler to sell wholesale framing products through to a consumer through a retailer is disclosed. The method includes receiving a purchase order from the retailer for at least one wholesale framing product via a computer network. The purchase order includes multiple state of assembly options and a selection, by said retailer, of one of the multiple state of assembly options. The method also includes shipping the at least one wholesale framing product assembled according to the selected state of assembly option to the retailer.

According to one aspect of the present disclosure, a method for notifying a retailer of a status of at least one purchase order is disclosed. The method includes generating a retail website as a front-end for a back-end database of wholesale framing products, monitoring a status of a purchase order completed through the retail website by a consumer, and notifying the retailer the status of the purchase order based on a lapse of a time interval and the retailer not transmitting the purchase order to a wholesaler. The purchase order includes at least one wholesale framing product. The retail website is hosted by at least one computer in communication with a computer network.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow diagram of a method of increasing sales for a retailer of framing products according to one embodiment of the present disclosure.

FIG. 2 is a flow diagram of a method of increasing sales for a retailer of framing products including outputting a captured purchase order.

FIG. 3 is a flow diagram of a method of increasing sales for a retailer of framing products including generating a retail website.

FIG. 4 is a flow diagram of a method for selling picture frame products through a retail website according to the present disclosure.

FIG. 5 is a flow diagram of a method including receiving a submission from a user of a retail website.

FIG. 6 is an example display illustrating a retail website including a virtual build feature according to one embodiment of the present disclosure.

FIG. 7 is an example display illustrating a retail website including a wholesale framing product.

FIG. 8 is a flow diagram of a method of increasing sales for a retailer of framing products through a retail website.

FIG. 9 is a flow diagram of a method notifying a retailer of a status of at least one purchase order based on retailer activity.

FIG. 10 is a flow diagram of a method notifying a retailer of a status of at least one purchase order according to one embodiment of the present disclosure.

FIG. 11 is a block diagram of a system for providing a picture frame point-of-sale program to a retailer.

FIG. 12 is an example display illustrating a point of sale program.

FIG. 13 is an example display for creating a purchase order.

FIG. 14 is an example display for viewing one or more purchase orders.

FIG. 15 is an example display for editing a purchase order.

FIG. 16 is an example display for editing customer information.

FIG. 17 is an example display for viewing retailer stock, which includes a line of framing products offered to consumers.

FIG. 18 is an example display for viewing a payment history.

FIG. 19 is an example display for viewing a retail report.

FIG. 20 is a flow diagram of a method of selling framing products including generating a retail website and providing a point of sale program.

FIG. 21 is a flow diagram of a system for selling picture frame products through a retailer including a point of sale program and a retail website.

FIG. 22 is a flow diagram of a method including shipping a wholesale framing product according to a selected state of assembly option.

FIG. 23 is an example display for illustrating multiple state of assembly options.

FIG. 24 is an example display for requesting a complete assembly for a frame product.

FIG. 25 is an example display for requesting a framing product as raw material.

FIG. 26 is a block diagram of a system for cutting a picture frame matte based on parameters received via a computer network.

### DETAILED DESCRIPTION

The following description is merely exemplary in nature and is not intended to limit the present disclosure, application, or uses.

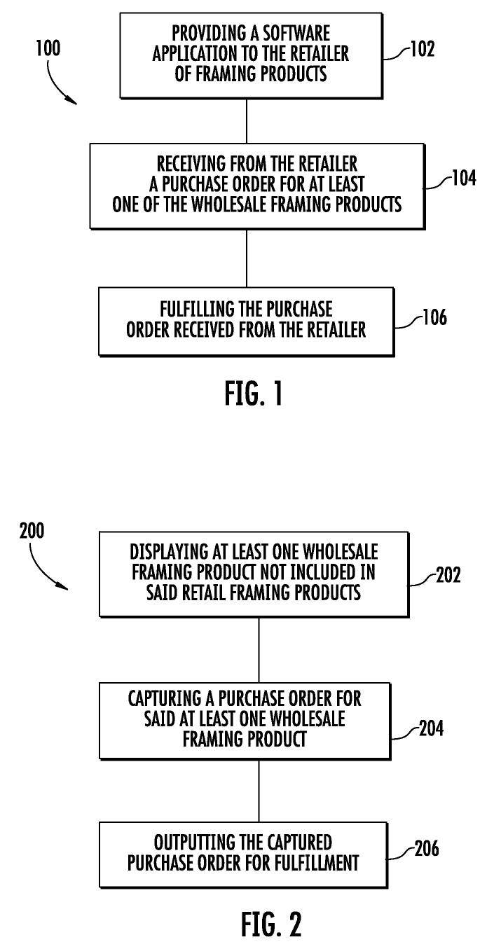

According to at least one embodiment of the present disclosure, a method of increasing sales for a retailer of framing products is illustrated in FIG. 1 and generally referenced 100. The method 100 includes step 102 for providing a software application to the retailer of framing products. The retailer has a line of framing products including retail framing products for offering to consumers. The software application includes a database of wholesale framing products not included in said retail framing products to thereby expand the line of framing products offered to consumers by the retailer. The method 100 includes step 104 for receiving from the retailer a purchase order for at least one of the wholesale framing products and step 106 for fulfilling the purchase order received from the retailer. The purchase order is taken by the retailer from a consumer using the software application.

The software application may include a point of sale program and/or a program for generating a retail website, as described in more detail below. The software application can be utilized by a small and/or larger retailer to expand a line of framing products offered to consumers. For example, a brick and mortar store at least partially dedicated to offering retail framing products to consumer can include as much or as little of a back-end database of wholesale framing products in either a point of sale program or a retail website generated from the software application. In this manner, the brick and mortar store is able to overcome one or more limitations related to a size of the brick and mortar store, a location of the brick and mortar store, and/or resources of the retailer to provide a consumer with an expansive line of framing products from which to choose.

It should also be appreciated that, in some embodiments, the software application can be provided to the retailer on a computer-readable medium, while downloaded through a computer network in other embodiments.

According to at least one embodiment of the present disclosure, a computerized method 200 of increasing sales for a retailer of framing products is illustrated in FIG. 2. The retailer has a line of framing products including retail framing products for offering to consumers. The method 200 includes step 202 for displaying at least one wholesale framing product not included in said retail framing products, step 204 for capturing a purchase order for said at least one wholesale framing product, and step 206 for outputting the captured purchase order for fulfillment.

Displaying the at least one wholesale framing product can be at a computer at the retailer location or via a computer network. In some implementation of method 200, a retailer location may include a brick and mortar store at least partially dedicated to offering retailer framing products to consumers. For example, a brick and mortar store of limited size may partner with a wholesaler to implement method 200. In doing so, the retailer is able to display to a consumer a line of framing products outside practical limitations of a size of the brick and mortar store and/or resources of the retailer. In another example, a wholesaler, partnered with a retailer, can display the retailer framing products of the retailer on a retail website accessible by consumers via a computer network, e.g., the Internet, etc. The wholesaler and/or retailer involvement in the retail website is described in more detail below.

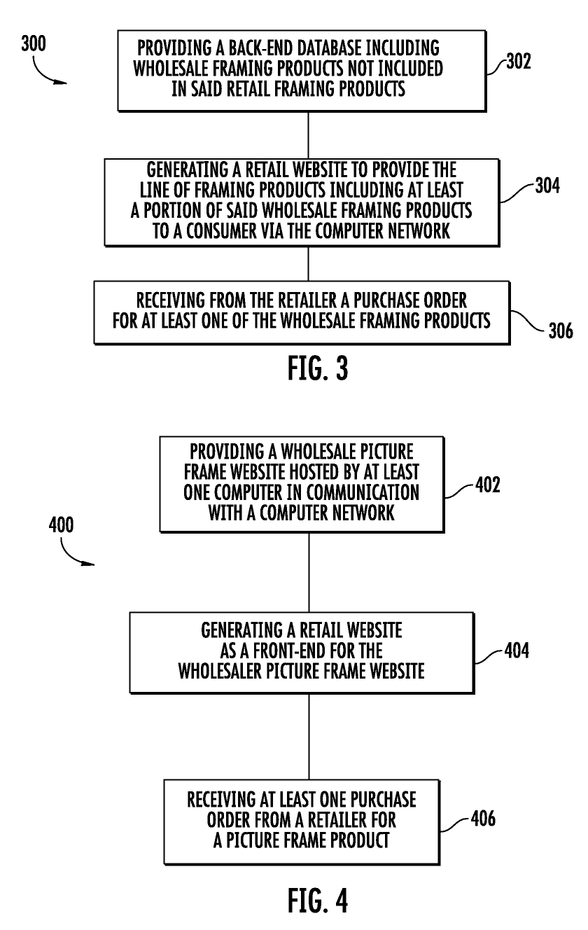

According to at least one embodiment of the present disclosure, a method 300 of increasing sales for a retailer of framing products through a retail website is illustrated in FIG. 3. The retailer has a line of framing products including retailer framing products. The method 300 includes step 302 for providing a back-end database including wholesale framing products not included in said retail framing products. The database is hosted by at least one computer in communication with a wide area network. The method 300 includes step 304 for generating a retail website to provide the line of framing products including at least a portion of said wholesale framing products to a consumer via the computer network and step 306 for receiving from the retailer a purchase order for at least one of the wholesale framing products. The purchase order is taken by the retailer from the consumer via the retail website. In this manner, a retailer is able to expand the line of framing products available to a user, e.g., a consumer, of the retail website.

According to at least one embodiment of the present disclosure, a method for selling picture frame products through a retailer is illustrated in FIG. 4. The method 400 includes step 402 for providing a wholesale picture frame website hosted by at least one computer in communication with a computer network and step 404 for generating a retail website as a front-end for the wholesale picture frame website. The retail website is the front-end for the wholesale website to the extent that a user interacts with the wholesale picture frame website via the retail website. The retail website is accessible to the user via a retailer network designator. In other embodiments, a retail website can be a front-end for a back-end database including multiple wholesale framing products, associated with or not associated with a wholesale website.

Method 400 also includes step 406 for receiving at least one purchase order from a retailer for a picture frame product.

A retailer network designator defines a location of a retail website on a computer network. Because different types of computer networks can be included in various implementations, different types of network designators are also included to define the location of a retail website. For example, when a network is an Internet, a network designator can include a uniform resource locator or URL. In other exemplary implementations, different types of computer networks can be employed, such as a local area network (LAN), a wide area network (WAN), a metropolitan area network (MAN), etc. The computer network can also be a private or a public network. From the example above, the Internet is generally a public network accessible to the general public. In another example, a computer network can be an Intranet with the network designator being a server/document address. For each different computer network, a corresponding network designator provides the location of the retail website on the computer network.

The computer network disclosed in the methods above can be hosted by at least one computer in communication with the computer network. The at least one computer can be a server provided by a wholesaler, in which case the wholesaler server hosts the wholesale picture frame website. In at least one implementation, the wholesale server also hosts the retail website. In other implementations, a different computer in communication with the computer network can host the retail website, such as a server provided by a retailer.

Referring again to FIG. 4, the retail website is a front-end for a wholesale picture frame website to provide interaction with the wholesale picture frame website through the retail website. In some implementations of at least one embodiment, a retail website provides at least one module hosted by a wholesale picture frame website for use by a user of the retail website. For example, if a wholesale picture frame website can include a shopping cart module. The retail website can be generated such that a user of the retail website can use the shopping cart feature of the wholesale picture frame website. In another example, a user can virtually build a picture frame product via a virtual build module, as disclosed below. It should be understood that other modules provided by the wholesale picture frame website may be accessible through the retail website to minimize content included in the retail website and/or simplify generation of the retail website.

In addition to modules included in the wholesale picture frame website, a user of a retail website can access a back-end database of wholesale framing products through the retail website. Since the back-end database is at least partially provided by a wholesaler, the back-end database can include numerous wholesale framing products unavailable through the retailer alone. The back-end database can be made totally or partially accessible to a consumer by the retailer. A retailer may provide accessibility to only a subset of the back-end database for a number of reasons, e.g., simplify user selections, etc. A different retailer, however, may provide access to the entire back-end database for other reasons, e.g., to maximize a number of frame products available to the user, etc.

The back-end database is a wholesale stock database, which includes wholesale framing products made available by the wholesaler. Additionally, the retailer can add one or more retail framing products to a retail stock database accessible to the consumer through the retail website. The retail stock database may include retail framing products, such as a frame, a matte, a backing material, glass, a glass substitute, etc. While any of these framing products may be include in the retail stock database, the retail framing products generally includes artwork, such as a print, a sketch, a drawing, a picture, an illustration, a design, a painting, etc. The retail stock database and the wholesale stock database can be wholly or partially accessible to a user through the retail website, depending on retailer and/or wholesale preferences.

In general, generating a retail website includes receiving at least some information from a retailer. Accordingly, a number of methods for selling picture frame products include registering a retailer via the computer network. Registering a retailer generally involves receiving retailer specific information, such as a retailer name and/or a retailer address. The information received from the retailer allows a wholesaler, directly or via a wholesale picture frame website, to create a retailer account. By accessing the retailer account, the retailer can request generation of a retail website. The retailer can choose from multiple templates available in a software application, and the retail website may then be customized to the retailer's preferences. For example, the retailer has the ability to set price mark-ups for one or more of the products displayed on the retail website, whether included in a wholesale stock database or a retailer stock database. The retailer may further provide retailer preferences for handling captured purchase orders. For example, a retailer can provide for automatic forwarding of purchase order to a wholesaler, or automatic forwarding of a portion of a purchase order including wholesale framing products to a wholesaler. The retailer preferences may automatically include a state of assembly option, as discussed below, when transmitted to a wholesaler. In some implementations, captured purchase orders may be fulfilled automatically, based on retailer preferences, without retailer action on the particular purchase order. In other implementations, retailer specific information can be provided to customize the retail website, such as one or more of a retailer specific URL, a retailer logo, a webpage template, a retailer email address, a wholesale picture frame website module, a retail stock database, and a color scheme.

In another implementation of at least one embodiment, a method for selling picture frame products through a retail website can include updating content included in the retail website. Content included in a retail website often includes dynamic information such as prices. Updating the content assures the most up-to-date prices and information are displayed to a user of a retail website. Retail website updates can be provided on command from the wholesaler and/or retailer or occur in regular intervals. For example, a retail website can be set up to update on the fifteenth of every month. Other intervals may be chosen depending on the particular implementation of the retail website.

According to another embodiment of the present disclosure, a method for selling picture frame products through a retail website is illustrated in FIG. 5. Method 500 includes step 502 for generating a retail website hosted by at least one computer in communication with a computer network. Method 500 also includes step 504 for receiving a submission from a user of the retail website and step 506 for receiving at least one input to virtually build a picture frame product for the submission. While a submission can include any type of frame product, the submission will often include a piece of artwork, such as a print, sketch, a drawing, a picture, an illustration, a design, or a painting.

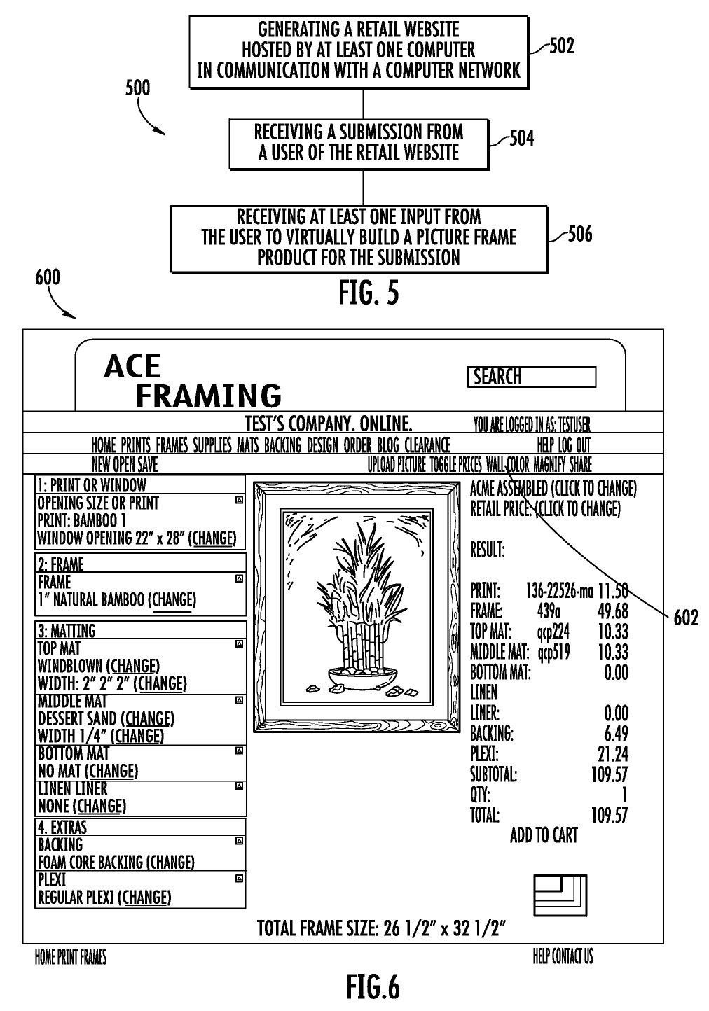

Once the submission is received by the retail website, a user can build a virtual picture frame product including the submission. As shown in example display 600 of FIG. 6, a user can view the virtual picture frame product before placing the frame product in a shopping cart for purchase. The user can select one or more of a frame, a first matte, a second matte, a backing, a glass or glass substitute (plexiglass), etc. The user enters the dimensions of the print, such that the retail website, along with other inputs from the user, can determine the dimensions of the selected framing products. Based on the selected framing products, either retail or wholesale, the print is displayed as included in the virtual picture frame product, as shown in example display 600. Although not visible, a foam backing and a plexiglass glass substitute can be included in the virtual picture frame product. The user can change one or more of the selected framing products or specified dimensions.

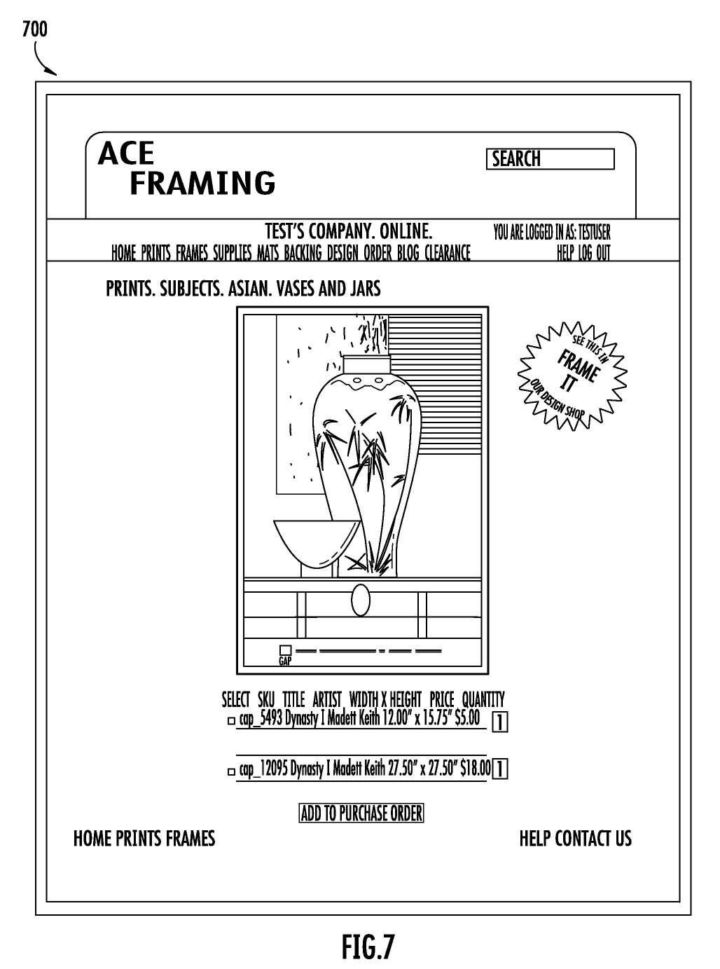

If changes are provided by the user, the example display 600 updates the virtual image of the virtual picture frame product. The example display 600 also updates price listing and totals along the right side. Although the virtual picture frame product is disclosed in the context of a user submission, it should be understood that a wholesale frame product from a back-end database can also be included in building a virtual picture frame product. For example, example display 700 includes a print of a vase from a back-end database, as shown in FIG. 7. A user of a retail website can select the vase print and build a virtual picture frame product as described above with reference to FIG. 6.

In addition to building the virtual picture frame product, a wall color button 602 is provided in a menu bar, as shown in example display 600. The wall color button 602 allows a user of the retail website to change the background of the webpage to simulate the final background upon which the frame product will be placed or hung. For example, the bamboo frame products illustrated in FIG. 6 may be intended for a dark green wall. By selecting the wall color button, the user can change the background from the tan (not visible) to dark green in order to simulate the intended dark green wall upon which the bamboo frame product in intended to hung. The wall color button 602 allows a complete virtual impression of one or more framing products to be displayed to the consumer before completing a purchase order.

Building of a virtual picture frame product is not limited to a user of a retail website. A designer, a retailer, and/or a wholesaler can build a virtual picture frame product for a submission from a user. For example, a retailer can receive a submission from a user through a retail website. The retailer can build a virtual picture frame product based on any number of factors including a user's suggestion, colors included in the submission, an intended background, etc. Once the virtual picture frame product is built, the retailer can transmit the virtual picture frame product related to the submission to the user via a computer network. The user can provide approval and/or feedback. The user can reply with feedback to indicate a suggested change to the virtual picture frame product. The user can reply with an approval to request that a purchase order for the virtual picture frame product be completed.

According to one embodiment of to the present disclosure, a method of increasing sales for a retailer of framing products through a retail website is illustrated in FIG. 8. The method 800 includes step 802 for generating a retail website hosted by at least one computer in communication with a computer network. The retail website is a front-end for a back-end database of wholesale framing products. The method 800 also includes step 804 for receiving at least one user input to build a virtual picture frame product including at least one of the wholesale framing products and step 806 for storing information sufficient to reproduce the virtual picture frame product in memory accessible via the computer network. The information being associated with a network designator. The method 800 includes step 808 for sending the network designator to the consumer thereby providing access to the virtual picture frame product via the computer network.

In this manner, a virtual picture frame product can be saved and reviewed at a later time. The virtual picture frame product can be passed through multiple people, e.g., consumer, retailer wholesale, designer, etc., in order to ensure the consumer's absolute approval. The consumer or another person can include one or more alterations when viewing, and save the alterations, such that information related to the alterations is stored in memory. The information is sufficient to ensure the virtual picture frame product, when subsequently viewed, includes the alteration made by the retailer, the consumer or another person. In one example, a retailer can, as described above, build a virtual picture frame product based on input and/or suggestions from a consumer and send it to a consumer, via email, for approval.

In various embodiments, a retailer website may require a consumer to register before submitting a purchase order. Registering the consumer may include receiving information, such as contact information, a mailing address, a billing address, an email address, a method of payment, etc. The information is generally stored in memory such that when the consumer logs-onto the retail website, the information may be recalled as needed. In other embodiments, a consumer may complete a purchase order as a guest without registering to a retail website.

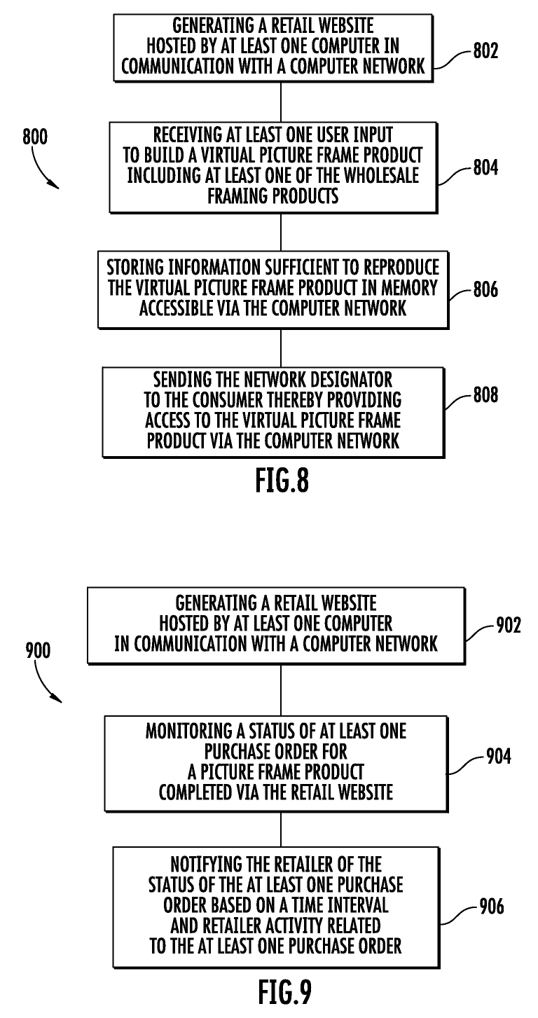

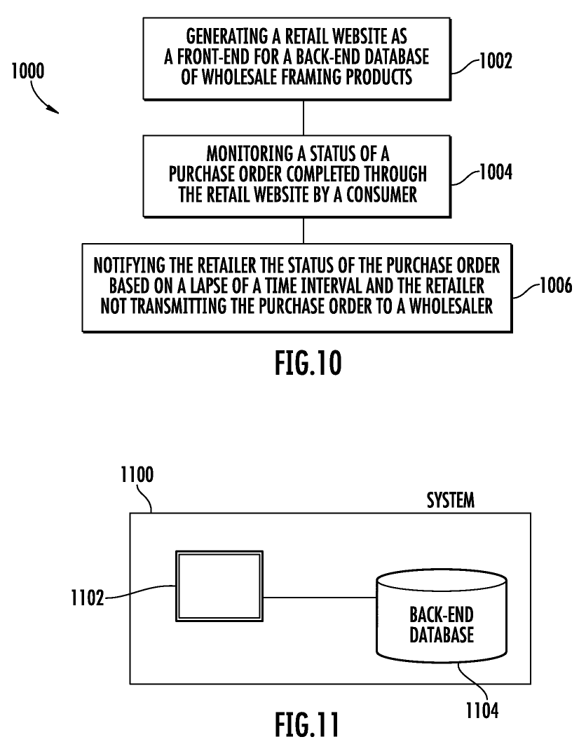

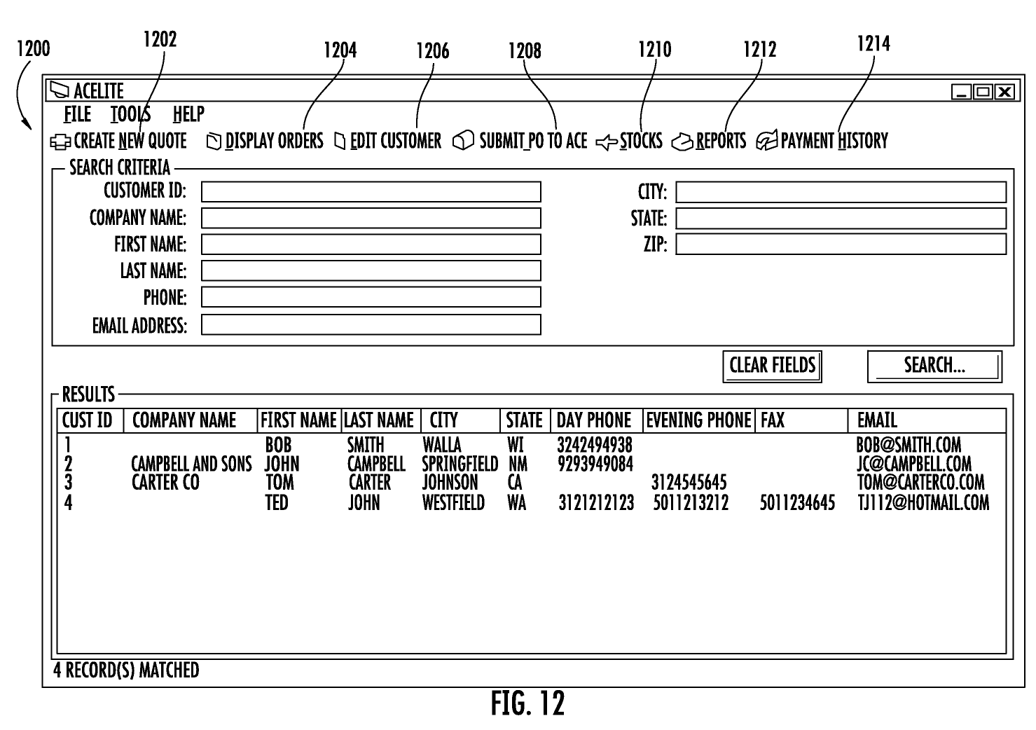

According to at least one embodiment of the present disclosure, a method 500 for notifying a retailer of a status of at least one purchase order is illustrated in FIG. 9. The method 900 includes step 902 for generating a retail website as a front-end for a wholesale picture frame website. The retail website is hosted by at least one computer in communication with a computer network. Method 900 also includes step 904 for monitoring a status of at least one purchase order for a picture frame product completed via the retail website and step 906 for notifying the retailer of the status of the at least one purchase order based on a time interval and retailer activity related to the at least one purchase order.

According to one embodiment of to the present disclosure, a method for notifying a retailer of a status of at least one purchase order is illustrated in FIG. 1000. The method 1000 includes step 1002 for generating a retail website as a front-end for a back-end database of wholesale framing products. The retail website is hosted by at least one computer in communication with a computer network. The method 1000 also includes step 1004 for monitoring a status of a purchase order completed through the retail website by a consumer and step 1006 for notifying the retailer the status of the purchase order based on a lapse of a time interval and the retailer not transmitting the purchase order to a wholesaler. The purchase order includes at least one wholesale framing product.

In various implementations, a retailer can be a small end retailer, e.g., an artist selling his/her own paintings and photographs. The small end retailer is often limited by time and resources to the extent that the retailer may not routinely check for new and/or completed purchase orders placed through the retail website. As a result, a purchase order can be completed by a user of a retail website and be unknown to the retailer. Accordingly, no action can be taken with regard to the purchase order until the retailer realizes the purchase order has been completed, potentially causing a delay in the consumer receiving his/her framing products. Depending on the retailer, an interval between completion of the purchase order and activity related to filling the purchase order can be days, hours, or even weeks. By monitoring a status of a purchase order and notifying the retailer of the status, an interval between completion of a purchase order and activity to fill the purchase order can be minimized.

Activity can include the retailer completely filling a purchase order. Alternatively, a retailer may transmit a portion of a purchase order to a wholesaler for fulfillment. By forwarding the portion of the purchase order to the wholesaler, the retailer can expand the types and quantities of framing products available to its consumers and/or retail website users. The retailer can determine which portion of the purchase order to transmit to the wholesaler based on, for example, if wholesale framing products are included in the purchase order. In some instances, the entire purchase order is wholesale framing products from a wholesale stock database, in which a retailer may decide to forward the entire purchase order to the wholesaler. The retailer can even instruct the wholesaler to ship the framing products directly to the consumer, which limits the retailer's involvement in fulfilling the purchase order.

As disclosed above, notifying the retailer can minimize the time interval between completion of a purchase order and activity to fill the purchase order. A time interval, e.g., a predetermined delay, between recognizing a completed purchase order and notifying the retailer is dependent on one or more of a type of retailer, resources available to a retailer, a consumer expectation, etc. The time interval before notifying the retailer can be set by the retailer and/or the wholesaler. As an example, a typical interval may be one or two days.

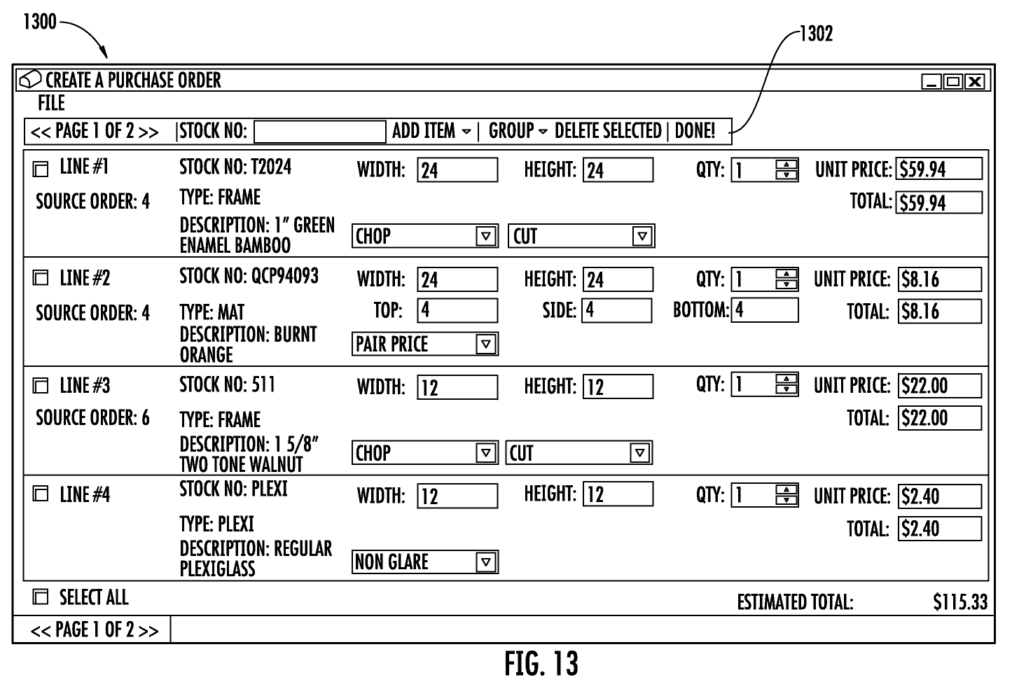

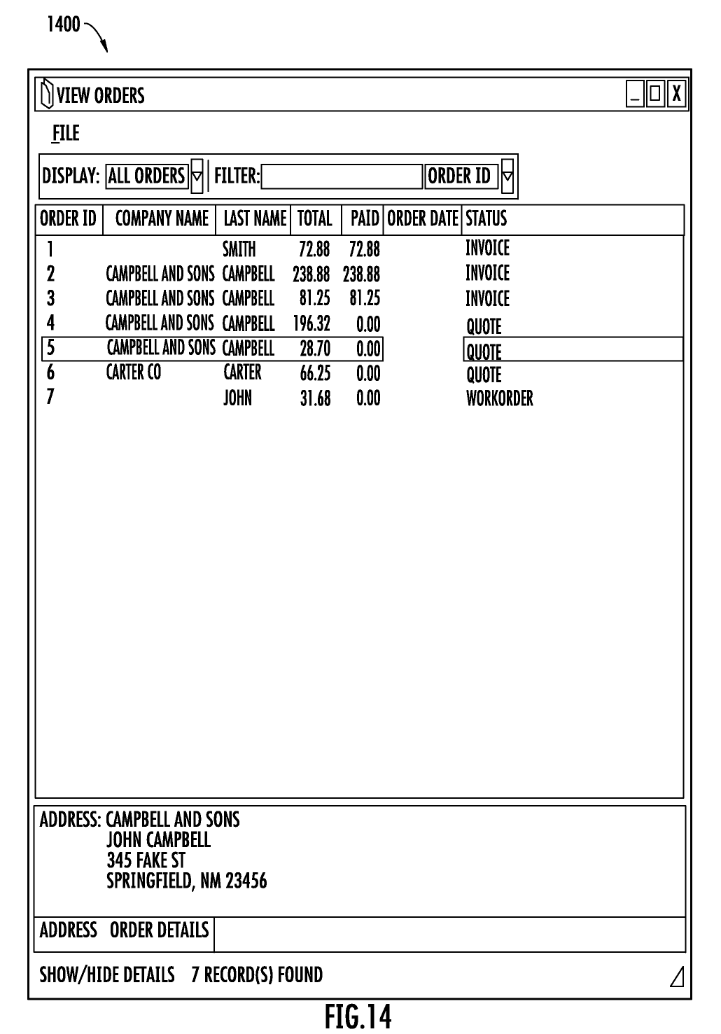

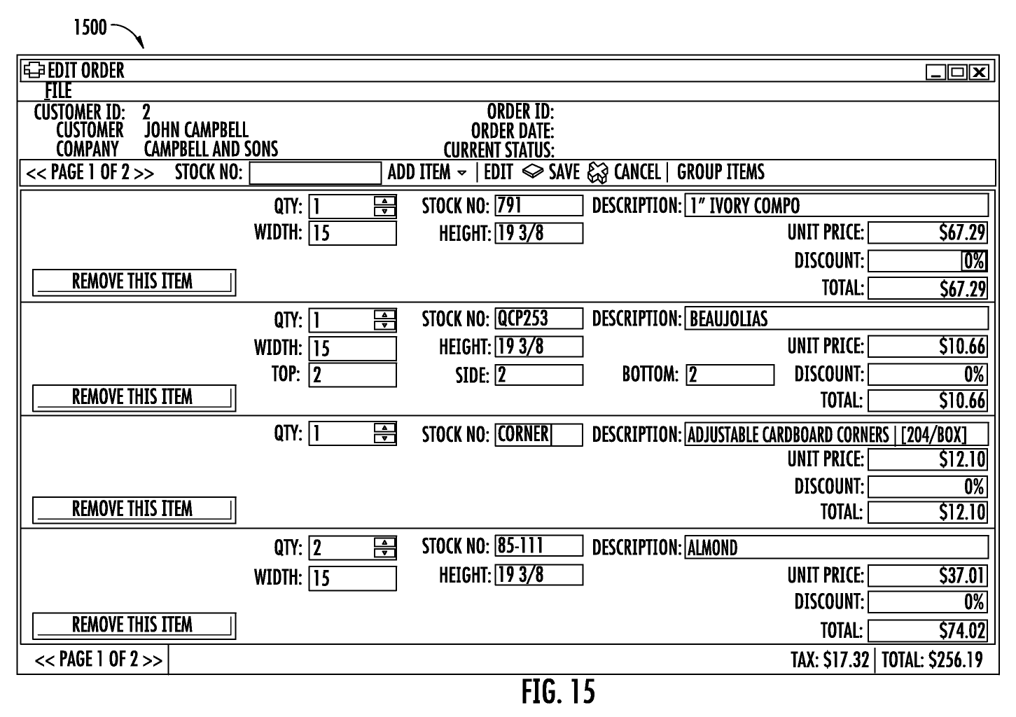

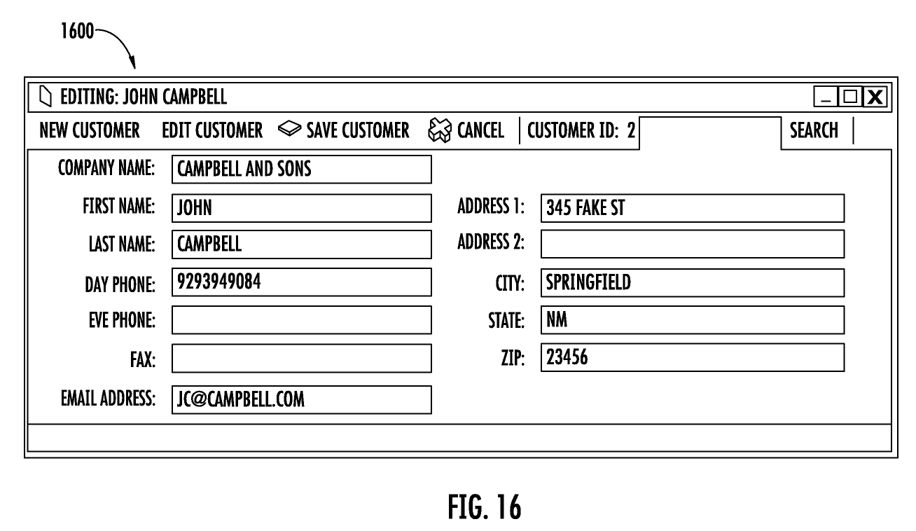

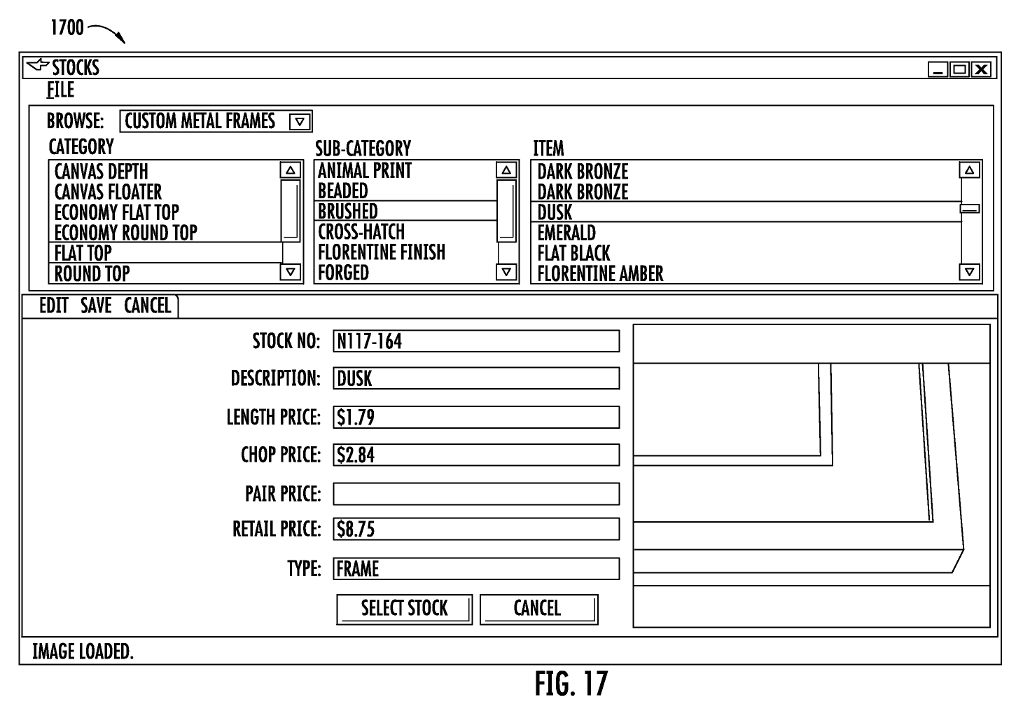

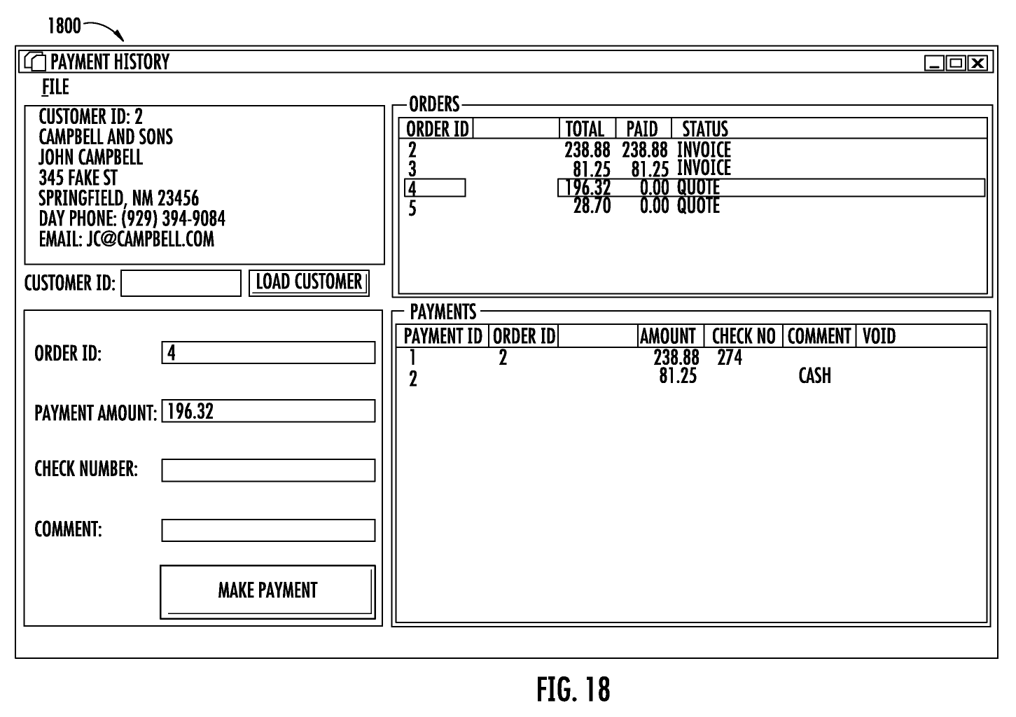

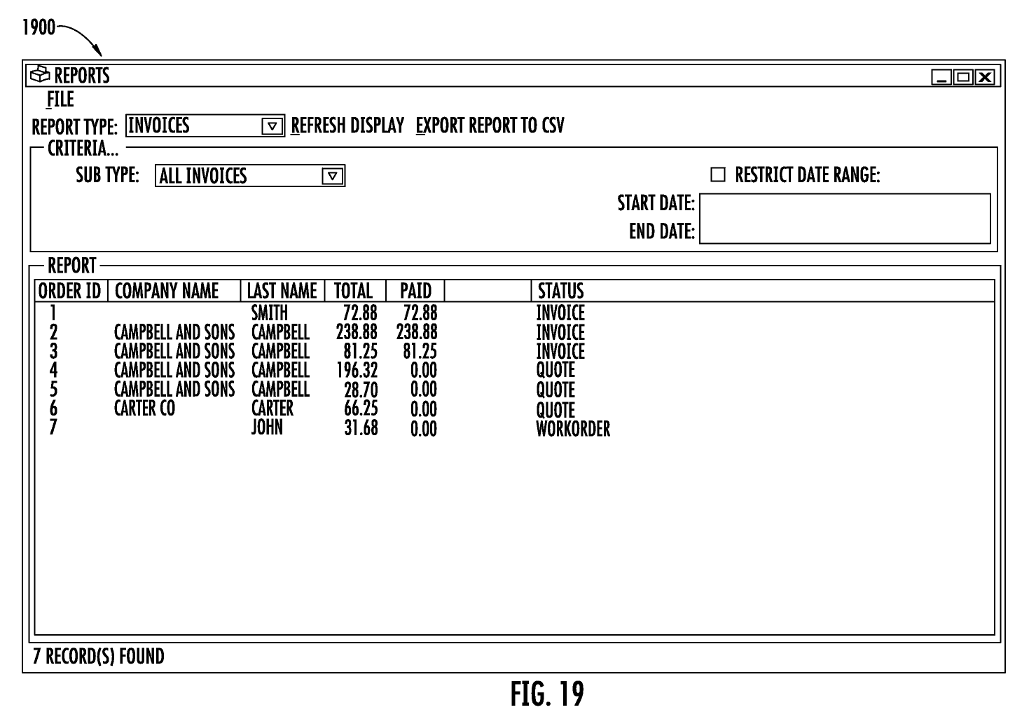

According to at least one embodiment of the present disclosure, a system 1100 for providing a software application, e.g., picture frame point-of-sale program, to a retailer is illustrated in FIG. 11. The system 1100 includes a processor 1102 located at the retailer premises, a memory 1104 operatively coupled to the processor, and a point of sale program stored in the memory and executable by the processor for compiling at least one purchase order, in response to a retailer input, for at least one framing product selected from a line of framing products and transmitting said purchase order to a wholesale. The line of framing products includes retail framing products and a back-end database of wholesale framing products not included in said retail framing products to thereby expand the line of framing products offered by the retailer.

In exemplary implementation of the system 1100, an example display 1200 illustrates a point of sale program, shown in FIG. 1200. The point of sale program permits a retailer to create a new quote via a new quote button 1202. When the retailer selects button 1202, example display 1300 is displayed to the retailer. In example display 1300, the retailer can compile a purchase order for at least one frame product. Once the purchase order is complete and a done button 1302 is selected by the retailer, the retailer is returned to the example display 1200. From example display 1200, the retailer can select a number of options including: displaying orders 1204, editing a customer 1206, submitting a purchase order 1208, viewing stock 1210, viewing reports 1212, and viewing payment history 1214. From each of these buttons in the menu tool bar, a different example display is displayed to the retailer. In some embodiments, the point of sale program may include accounting functionality and other functionality disclosed herein such that all business related to a framing products business, including retail framing products and wholesale framing products, may be managed through the point of sale program.

Specifically, when the retailer selects displaying orders 1204, example display 1400 is displayed to the retailer. From example display 1400, the retailer can view purchase order, which have been invoiced, quoted, and/or completed. In one example, a system for providing a picture frame point-of-sale program to a retailer includes a module executable by the processor for viewing a status of previously compiled purchase order. Referring again to example display 1400, details and/or status regarding each of the purchase orders can be viewed by clicking on the entry. When the entry is selected, example display 1500 is displayed to the retailer for viewing purchase order completed through the point of sale program. From example display 1500, the retailer can edit, remove, and/or added one or more framing products included in a purchase order. When the retailer selects editing a customer 1206 from example display 1200, example display 1600 is displayed to the retailer. From example display 1600, the retailer can create and/or edit a customer entry, such as changing address and contact information.

When the retailer selects viewing stock 1210 from example display 1200, example display 1700 is displayed to the retailer. From example display 1700, the retailer can view and manage framing products within a database including retail framing products and the back-end database of wholesale framing products. The retailer can add, remove, or edit framing products within the database. For example, a retailer can edit a price mark-up for a particular frame product in stock. The retailer also has control to manage the database with respect to the wholesale framing products and/or the retail framing products. When the retailer selects viewing payment history 1214 from example display 1200, example display 1800 is displayed to the retailer. From example display 1800, the retailer can view a payment status regarding a particular purchase order and/or payments made and/or due on the particular purchase order. A payment history can be related to a payment due to a retailer or due to one or more other individuals filling the purchase order, such as a wholesaler.

If the retailer selects submitting purchase order 1208 from example display 1200, a particular implementation of the system dictates the result of the selection. For a system including a network interface, the purchase order can be transmitted electronically via the network interface to a wholesaler. If the network interface communicates via an Internet connection, a purchase order can be transmitted from the point of sale program via the Internet connection. Alternatively, a network interface can communicate via a telephone line. With a telephone connection, a purchase order can be transmitted to the wholesaler via facsimile and/or the Internet. In either implementation, a purchase order can be forwarded to a wholesaler automatically upon completion of the purchase order, based on one or more retailer preferences. If the system does not include a network interface, the purchase order can be printed or placed on a computer readable medium for non-electronic shipment, such as U.S. Mail.

If the retailer selects viewing reports 1212 from example display 1200, example display 1900 is displayed. Example display 1900 allows the retailer to create and/or view reports related to one or more purchase orders quoted and/or completed through the point of sale program and/or a retail website. For example, a system for providing a point-of-sale program to a retailer can also include a module executable by the processor for creating a retail report related to at least one of a consumer name, a total amount due, a total amount paid, an order date, a status of an order, a purchase order, and another purchase order details. In some embodiments, a point of sale program can export a report to a database and/or spreadsheet tool known to those skilled in the art.

In another implementation of at least one embodiment, a system for providing a picture frame point-of-sale program to a retailer includes a memory associated with the processor. The system also includes a module executable by the processor to store a database in memory associated with the processor. The database includes one or more of a wholesale stock database and a retailer stock database. Further, the system can also include an input device for receiving at least one retail stock database entry from a retailer. The input device can be a keyboard, a mouse, a touch screen, a scanner, a network interface, a computer readable medium, etc.

The memory associated with the processor can be a number of different types of memory, such as RAM, ROM, DRAM, SDRAM, DDR, flash, hard disk, floppy disk, zip disk, CD, DVD, magnetic, mass storage, or any other computer readable medium. Referring again to FIG. 11, a memory 1104 associated with the processor 1102 is a hard disk, and the processor 1102 is a central processing unit (CPU). In other embodiments of a system according to the present disclosure, a processor can be a number of different processing devices, such as a microcontroller, a programmable logic device (PLD), a microprocessor, etc.

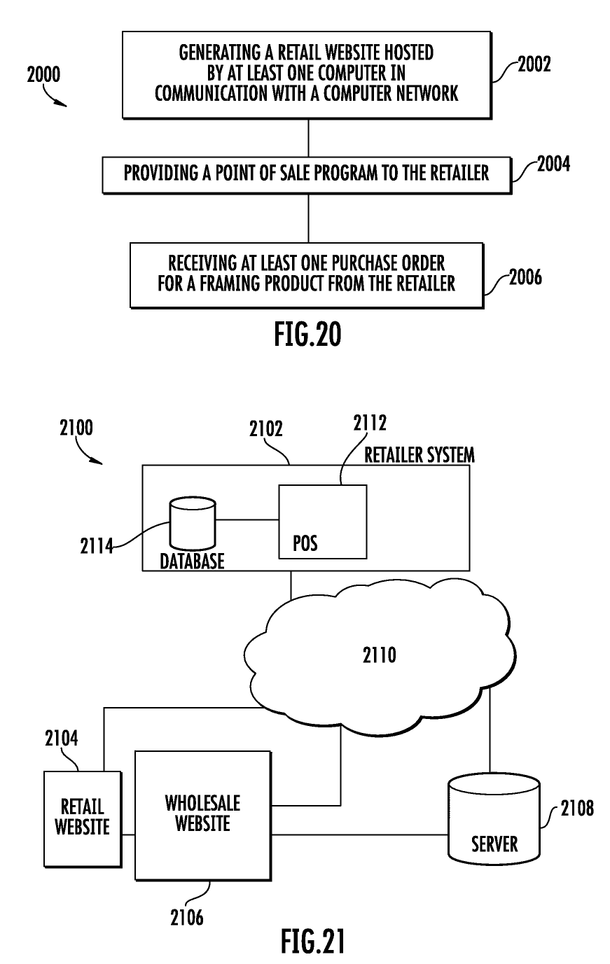

According one embodiment of the present disclosure, a method for selling picture frame products through a retailer is illustrated in FIG. 20. Method 2000 includes step 2002 for generating a retail website hosted by at least one computer in communication with a computer network and step 2004 for providing a point of sale program to the retailer. The point of sale program executable by a processor accesses a line of framing products for offering to consumers. The line of framing products including a back-end database includes wholesale framing products and retail framing products. Also, method 2000 includes step 2006 for receiving at least one purchase order for a framing product from the retailer. The at least one purchase order is created from one of the retail website and the computer executable program.

According to one embodiment of the present disclosure, a system 2100 for selling picture frame products through a retailer is illustrated in FIG. 21. The system includes a retailer system 2102, a retail website 2104, a wholesale website 2106, and a wholesale server 2108. The retail website 2104 is a front-end for the wholesale picture frame website, with each website being hosted by wholesale server 2108 in communication with a computer network 2110. The wholesale server 2108 is also an email server for the retail website, such that one or more of emails and html pages and/or requests can be transmitted to/from a retailer. The computer network 2110 is an Internet. The retailer system 2102 includes at least one computer 2112 in communication with the computer network 2110 for executing a point of sale program. The at least one computer 2112 can access a back-end database on the wholesale server and/or the back-end database can be pulled down to a retailer server 2114. The retail website can access the retailer server 2114 in the retailer system or the database included in the wholesale server 2108. Purchases order compiled in the point of sale program and the retail website 2104 can be viewed and/or edited by the retailer through each of the point of sale program and the retail website, via a retailer account.

It should be noted that each aspect disclosed herein with respect to the retailer website, wholesale picture frame website, and point of sale program may be included in the various implementations of an embodiment consistent with the block diagram illustrated in FIG. 21. For example, a retailer may utilize a software application for generating a retailer website. In another example, a retailer may utilize a software application from a wholesaler including the point of sale program only. In yet another example, a retailer may utilize a software application including both a retail website and a point of sale program, in which a wholesale website is not included and the software application including the retail website and the point of sale program directly accesses a back-end database.

The retail website 2104 can also include one or more modules of the wholesale picture frame website. For example, a consumer interacting with a retail website can use a module of the wholesale picture frame website to virtually build one or more frame products and a shopping cart module to manage a purchase through the retail website. The integration of the modules between the wholesale picture frame website and the retail website minimizes complexity of the retail website while maximizing the number of features available to the consumer.

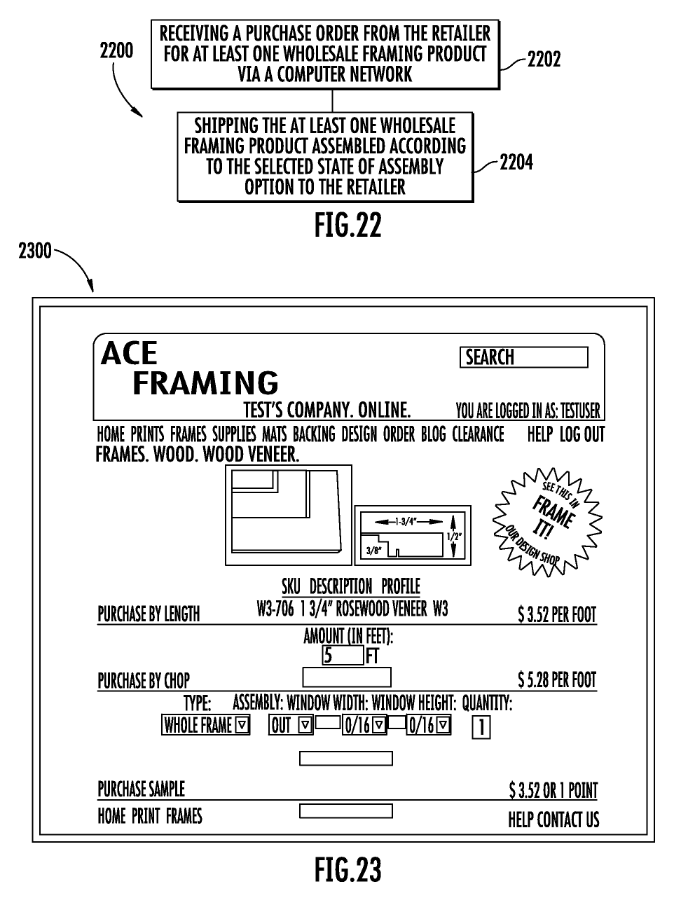

According to one embodiment of the present disclosure, a method for a wholesaler to sell wholesale framing products through to a consumer through a retailer is illustrated in FIG. 22. The method 2200 includes step 2202 for receiving a purchase order from the retailer for at least one wholesale framing product via a computer network. The purchase order includes multiple state of assembly options and a selection, by said retailer, of one of the multiple state of assembly options. The method 2200 further includes step 2204 for shipping the at least one wholesale framing product assembled according to the selected state of assembly option to the retailer.

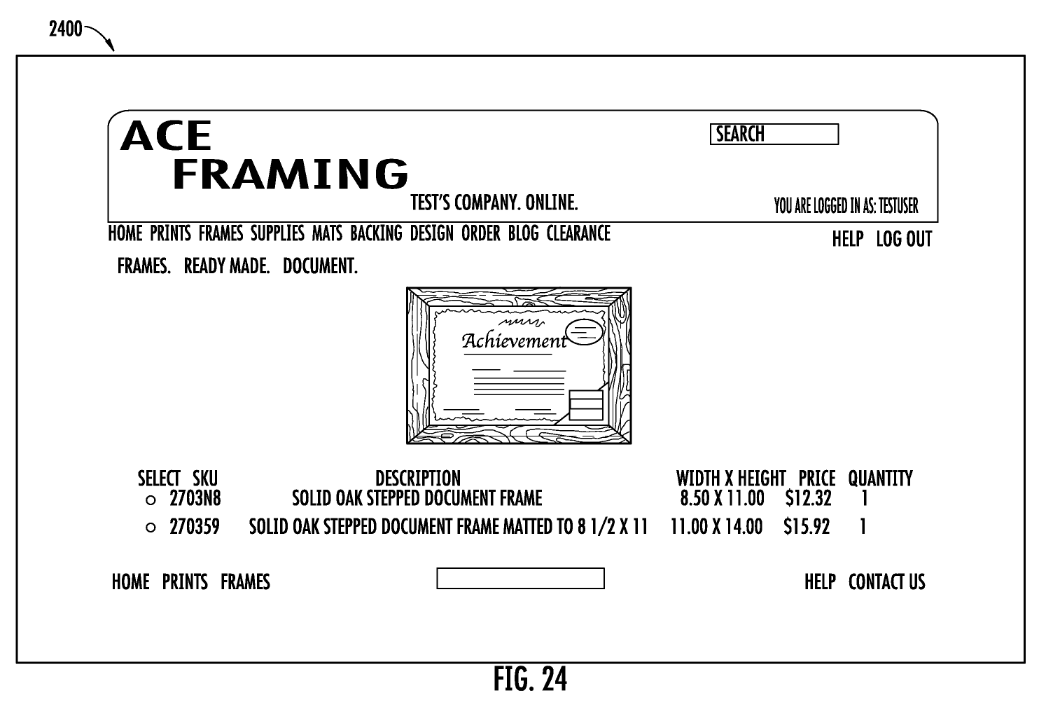

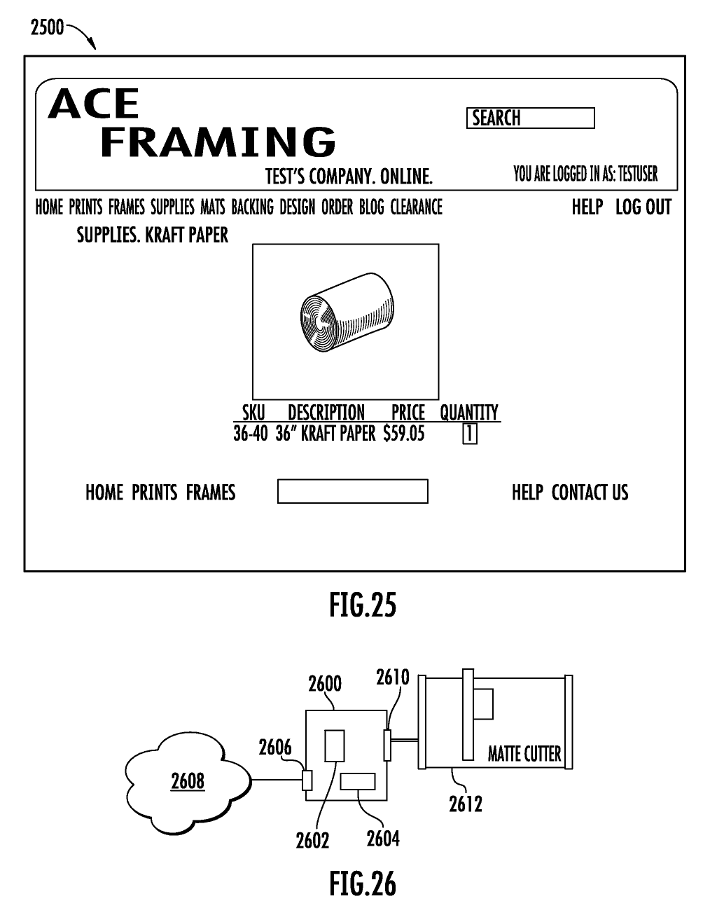

State of assembly options can include requests for raw material, a custom-cut material, a partially complete assembly of a framing product, or a complete assembly of a framing product. For various implementations, state of assembly options may include a number of different states of assembly dependent on the particular wholesale and/or retail framing products include in a purchase order. A framing product can be one or more of a print, a frame, a matte, a backing material, glass, or a glass substitute, such as plexiglass. As shown in example display 2300 of FIG. 23, a consumer of a retail website (or a retailer using a point of sale program) can request a state of assembly option for a framing product. The user can request the Rosewood Veneer by length or chop. By specifying a length, the consumer is selecting a raw material of the veneer. By specifying a chop and/or size, the consumer is selecting a custom-cut of the veneer. The custom-cut of the veneer can be shipped, to the consumer or retailer, as a custom-cut material or included in a complete assembly or partially complete assembly. In another example display 2400 of FIG. 24, a purchase order can request a complete assembly of framing products, such as a document frame product. In another example, a purchase order may include a print, a frame and a multi-opening matte. The purchase order may indicate a state of assembly option for each of the three products. The print is requested as raw material, thus the print will be shipped as raw material. The frame is requested custom-cut length, thus four custom-cut pieces for a four-sided frame at the requested length will be shipped. Or, a partially complete assembly selection can include the four custom-cut pieces of frame assembled into the four-sided frame. The multi-opening matte is requested to a certain dimension with two specified openings. Thus, the matte will be custom-cut as request before shipment. In a different example 2500, as illustrated in FIG. 25, a consumer of a retail website (or a retailer using a point of sale program) can request matte material be shipped as raw material.

A purchase order can also indicate to whom the frame products should be shipped. Depending on a number of factors, a retailer can have a portion of a purchase order filled by a wholesaler delivered to the retailer. For example, a retailer can order raw materials for shipment to the retailer. Upon reception of the raw materials, the retailer can produce the completed frame product before shipping or delivering to a consumer. In another example, the retailer can have the frame products shipped directly to a consumer. The retailer saves resources by not handling the frame product, and the consumer receives shipment faster.

According to yet another embodiment of the present disclosure, a system for cutting a picture frame matte based on parameters received via a computer network 2608 is illustrated in FIG. 26. The system 2600 includes a processor 2602, a memory 2604 coupled to the processor 2602, a network interface 2606 for interfacing the computer network 2608 and operatively coupled to the processor, an output device 2610 for coupling a matte cutting device 2612, and a program stored in the memory 2604 and executable by the processor 2602 for receiving a purchase order having parameters for a custom matte via the network interface 2606 and directing the matte cutting device 2612 via the output device 2610 to cut the custom matte according to the parameters.

The parameters included in a back-end database can include the length and width of a matte and an opening in the matte. The parameters can also specify the length and width for multiple openings in the picture frame matte. Additionally, parameters can be entered by a retailer or a consumer. When the retailer (or consumer) requests a framing product from a software application (e.g., a point of sale program), the retailer can include parameter corresponding to size and/or openings such that the matte cutter can cut a picture frame matte based on parameters requested. In other implementations, a database can include one or both of a back-end database and a retail framing products entered by the retailer, each having parameters to direct a matte cutting device.

While the present disclosure has been described with reference to certain preferred embodiments, it is to be understood that the present disclosure is not limited to such specific embodiments. Specifically, the various elements described in this disclosure may be combined, removed, or included in different combinations without departing from the scope of this disclosure. Other modifications and additions may be made without departing from the spirit and scope of this disclosure.

What is claimed:

1. A method of increasing sales for a retailer of framing products through a retail website, the retailer having a line of framing products including retailer framing products, the method comprising providing a back-end database including wholesale framing products not included in said retail framing products, the database being hosted by at least one computer in communication with a computer network, generating a retail website to provide the line of framing products including at least a portion of said wholesale framing products to a consumer via the computer network, and receiving from the retailer a purchase order for at least one of the wholesale framing products, the purchase order taken by the retailer from the consumer via the retail website.

2. The method of claim 1 wherein the purchase order indicates the state of assembly option of the at least one of the wholesale framing products.

3. The method of claim 1 wherein generating the retail website includes providing a virtual frame module accessible through the retail website, whereby the consumer is able to build a virtual picture frame product including the at least one of the wholesale framing products.

4. The method of claim 1 further comprising registering a retailer via the computer network and thereby receiving, from said retailer, one or more of a price mark-up, a retailer specific URL, a retailer logo, retailer preferences, and a color scheme.

5. The method of claim 1 further comprising shipping the at least one of the wholesale framing products to the consumer or the retailer.

6. The method of claim 5 wherein shipping framing products includes shipping the framing product assembled according to a state of assembly option included in the purchase order.

7. The method of claim 1 wherein the retail website is accessible on the computer network via a retail network designator, the computer network being an Internet, the retailer network designator being a URL.

8. The method of claim 1 wherein the at least one computer is a server provided by the wholesaler.

9. The method of claim 1 further comprising updating content included in the retail website to reflect at least one of a change in the back-end database, a price mark-up, and a retailer preference.

10. The method of claim 1 further comprising generating a wholesale website thereby providing the consumer direct access to the back-end database of wholesale framing products, without necessarily accessing the retail website.

11. The method of claim 10 wherein at least one feature included in the wholesale website and hosted on a server, associated with the wholesaler, is integrated into the retail website and accessible to a consumer via the retail website.

12. The method of claim 1 further comprising notifying the retailer of a status of fulfilling and/or shipping the wholesale framing product included in the purchase order.

13. A method of increasing sales for a retailer of framing products through a retail website, the method comprising generating a retail website hosted by at least one computer in communication with a computer network, the retail website being a front-end for a back-end database of wholesale framing products, receiving at least one user input to build a virtual picture frame product including at least one of the wholesale framing products, storing information in memory accessible via the computer network, the information being sufficient to reproduce the virtual picture frame product and associated with a network designator, and sending the network designator to the consumer thereby providing access to the virtual picture frame product via the computer network.

14. The method of claim 13 wherein sending the network designator includes generating an email including the network designator.

15. The method of claim 13 further comprising storing information sufficient to reflect an alteration to the virtual picture frame product made by one of a retailer and the consumer.

16. The method of claim 13 further comprising displaying the virtual picture frame product against a simulated background.

17. The method of claim 13 further comprising registering a retailer via the computer network and thereby receiving one or more of a price mark-up, the retailer specific URL, a retailer logo, retailer preferences, and a color scheme.

18. The method of claim 13 further comprising registering the consumer via the computer network and thereby storing contact information for the consumer in memory accessible via the computer network.

19. The method of claim 13 wherein sending the network designator to the consumer includes requesting approval for an alteration made to the virtual picture frame product by one of the wholesaler and the retailer.

20. A computer-readable medium having a computer-executable for performing the method of claim 13.

21-22. (canceled)

23. A method for a wholesaler to sell wholesale framing products through to a consumer through a retailer, the method comprising receiving a purchase order from the retailer for at least one wholesale framing product via a computer network, the purchase order including multiple state of assembly options and a selection, by said retailer, of one of the multiple state of assembly options and shipping the at least one wholesale framing product assembled according to the selected state of assembly option to the retailer.

24. The method of claim 23 wherein the multiple state of assembly options include raw material, custom cut material, and less than complete assembly.

25. The method of claim 23 wherein the at least one wholesale framing product includes one or more of a print, a frame, a matte, a multi-opening matte, backing, glass, and a glass substitute.

26. A computer-readable medium having a computer-executable for performing the method of claim 23.

27-29. (canceled)
